(19) United States
(12) Patent Application Publication
(10) Pub. No.: US 2009/0296853 A1
(43) Pub. Date: Dec. 3, 2009

(54) Rotation Direction Control for Phase Modulation

(75) Inventors: Meng-Chang Doong, Sunnyvale, CA (US); Jia-Yi Chen, Sunnyvale, CA (US); Thomas Lee, Burlingame, CA (US)

Correspondence Address: THE MUELLER LAW OFFICE, P.C., 12951 Harwick Lane, San Diego, CA, 92130, US

(73) Assignee: ZEROG WIRELESS, INC., Sunnnyvale, CA (US)

(21) Appl. No.: 12/129,681

(22) Filed: May 30, 2008

(51) Int. Cl. H04L 25/03

(52) U.S. Cl. 375/296; 455/110; 375/308

(57) ABSTRACT

A transmitter architecture and method of modulation that include a rotation-direction control circuit for varying the direction of rotation of phase transitions of a phase modulation based on the occurrence of a predetermined pattern of input data. This variation of rotation direction by the rotation-direction control circuit maintains the output spectrum of a modulated signal within the spectral mask requirements of an associated communications standard and thereby enables the use of non-linear power amplifiers in applications that generally require linear amplifiers.

The invention relates generally to phase modulation, and more specifically to methods and apparatuses that utilize rotation-direction control to control the output spectrum of a phase-modulated signal.

### BACKGROUND OF THE INVENTION

Phase modulation techniques, such as M-ary phase-shift keying (PSK) modulation, are frequently used in wireless communications systems. Traditional transmitter architectures for M-ary PSK modulation that include a pulse-shaping filter generally produce modulated signals that have a non-constant envelope. As a result, such transmitter architectures require fully linear power amplifiers. Fully linear power amplifiers are less efficient and consume significantly more power than non-linear power amplifiers. This can be particularly problematic for mobile wireless communications devices.

Various attempts have been made in the prior art to enable the use of non-linear power amplifiers in transmitter architectures that generally require linear power amplifiers. Polar modulation, for example, separates a signal into an amplitude modulation (AM) component and a phase modulation (PM) component. This separation enables a non-linear power amplifier to be used for the PM component, while the AM component is later re-combined by controlling the bias voltage of the power amplifier. Polar modulation, however, requires synchronization of the AM and PM path, which introduces added complexity to the transmitter architecture. Thus there remains a continuing need for improved methods and apparatuses for enabling the use of non-linear power amplifiers in applications that generally require linear power amplifiers.

### SUMMARY OF THE INVENTION

In one aspect of the invention, a method is provided for controlling the output spectrum of a modulated signal generated by phase modulation. The method includes the step of varying the direction of rotation of a phase transition of the phase modulation based on the occurrence of a predetermined pattern of input data.

In another aspect of the invention, a transceiver is provided for generating a modulated signal by phase modulation. The transceiver includes a pulse-shaping filter for controlling the speed of phase changes occurring during the phase modulation; and a rotation-direction control circuit for periodically reversing the direction of rotation of the phase changes based on the occurrence of a predetermined pattern of input data.

In yet another aspect of the invention, a communications terminal is provided for generating a modulated signal by constant-envelope phase modulation. The communications terminal includes a rotation-direction control circuit for varying the direction of rotation of phase transitions of the phase modulation based on the occurrence of a predetermined pattern of input data.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a signal trajectory for conventional BPSK modulation.

FIG. 2 illustrates a modulated signal waveform for the conventional BPSK modulation of FIG. 1.

FIG. 3a illustrates a BPSK signal trajectory that is consistent with a BPSK embodiment of the present invention.

FIG. 3B illustrates a QPSK signal trajectory that is consistent with a QPSK embodiment of the present invention.

FIG. 4 illustrates a modulated signal waveform that is consistent with the signal trajectories illustrated in FIGS. 3a and 3b.

FIG. 5 illustrates a block diagram of a conventional transmitter architecture for an IEEE 802.11 transmitter.

FIG. 6 illustrates a block diagram of a transmitter architecture that is consistent with an exemplary embodiment of the present invention.

FIG. 7 illustrates an exemplary embodiment of a rotation-direction control circuit for use in the transmitter architecture of FIG. 6.

FIG. 8 illustrates input data for the exemplary embodiment illustrated by the combination of FIGS. 6 and 7.

FIG. 9 illustrates the input and output of the pulse-shaping filter of the exemplary embodiment illustrated by the combination of FIGS. 6 and 7.

FIG. 10 illustrates the I and Q waveforms output by the polar-to-Cartesian circuit of the exemplary embodiment illustrated by the combination of FIGS. 6 and 7.

FIG. 11 illustrates an alternative embodiment of a state machine that is suitable for use with the rotation-direction control circuit of FIG. 7.

FIG. 12 illustrates a counter circuit that is suitable for use with the rotation-direction control circuit of FIG. 7.

FIG. 13 illustrates the impulse response of a pulse-shaping filter that is suitable for use with the exemplary embodiment illustrated by the combination of FIGS. 6 and 7.

FIG. 14 illustrates the output spectrum generated by the exemplary embodiment illustrated by the combination of FIGS. 6 and 7.

FIGS. 15, 16 and 17 illustrate packet-error rates for the exemplary embodiment illustrated by the combination of FIGS. 6 and 7.

FIG. 18 illustrates an alternative embodiment of the transmitter architecture of FIG. 6.

FIG. 19 illustrates an additional embodiment of a rotation-direction control circuit that is suitable for use with the transmitter architecture of FIG. 6.

FIG. 20 illustrates input data for the exemplary embodiment illustrated by the combination of FIGS. 6 and 19.

FIG. 21 illustrates the input and output of the pulse-shaping filter of the exemplary embodiment illustrated by the combination of FIGS. 6 and 19.

FIG. 22 illustrates the I and Q waveforms output by the polar-to-Cartesian circuit of the exemplary embodiment illustrated by the combination of FIGS. 6 and 19.

FIG. 23 illustrates the output spectrum generated by the exemplary embodiment illustrated by the combination of FIGS. 6 and 19.

### DETAILED DESCRIPTION

Reference now will be made in detail to embodiments of the disclosed invention, one or more examples of which are illustrated in the accompanying drawings. Each example is provided by way of explanation of the present technology, not limitation of the present technology. In fact, it will be apparent to those skilled in the art that modifications and variations can be made in the present technology without departing from the spirit and scope thereof. For example, features illustrated or described as part of one embodiment may be used on another embodiment to yield a still further embodiment. Thus, it is intended that the present subject matter covers such modifications and variations as come within the scope of the appended claims and their equivalents.

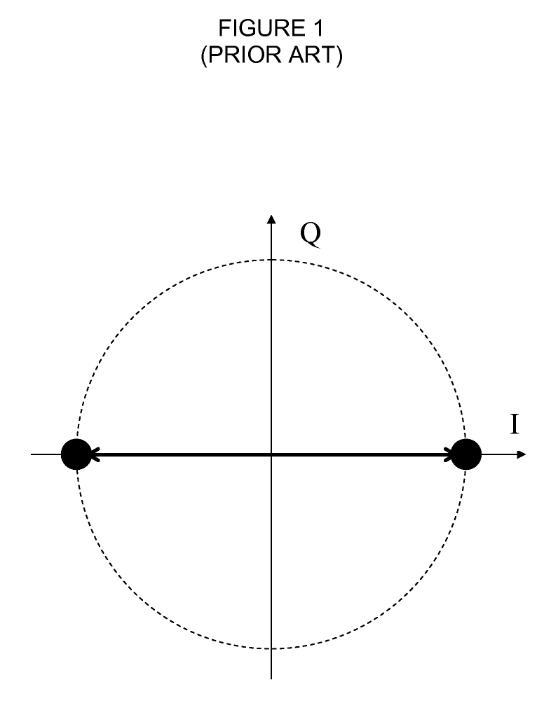

FIG. 1 illustrates the signal trajectory of the complex analog signal produced by conventional BPSK modulation. The I axis represents the real component of the modulated signal, and the Q axis represents the imaginary component of the modulated signal. The solid dots on the I axis correspond to the two binary values associated with BSPK modulation. The arrow-headed line that runs between the solid dots on the I axis represents the possible values of the amplitude of the BSPK modulated signal during phase transitions.

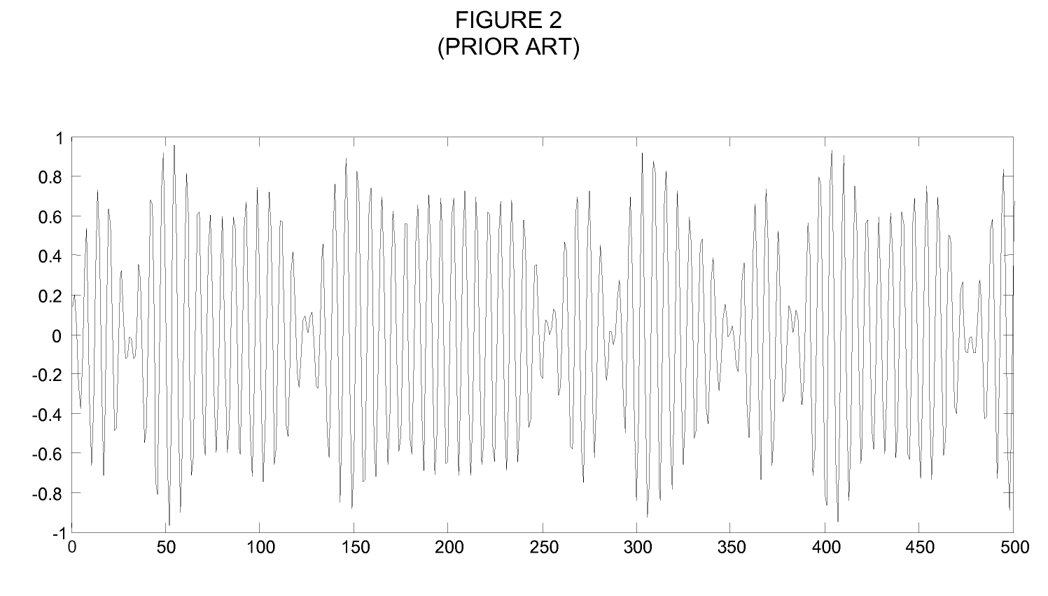

FIG. 2 illustrates a signal waveform that corresponds to the conventional BPSK signal trajectory illustrated in FIG. 1. As is apparent from the variations in the amplitude of the signal waveform, this modulation technique generates a modulated signal that has a non-constant envelope. This is generally true for other M-ary PSK modulation techniques as well. As a result of this non-constant envelope, a corresponding transmitter must generally implement a fully linear power amplifier. It would be highly desirable to utilize constant-envelope modulation in such a context in order to avoid the need for a linear power amplifier. However, constant-envelope modulation generally produces a modulated signal that has a wider output spectrum than the modulated signal produced by the corresponding non-constant-envelope modulation. This wider output spectrum may cause the modulated signal to exceed the spectral-mask limitations of an associated communications standard, such as the IEEE 802.11 standard.

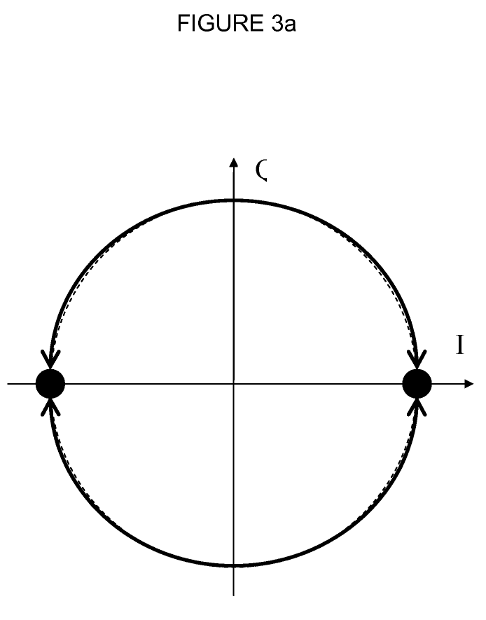

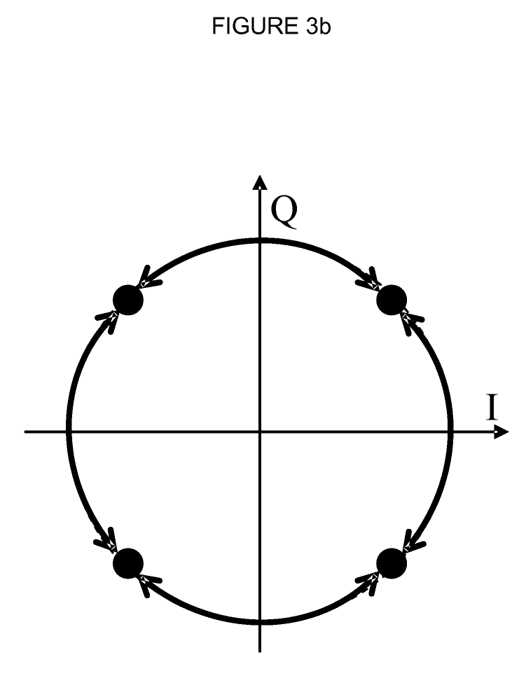

FIG. 3a illustrates a signal trajectory that is consistent with a BPSK embodiment of the present invention. The complex analog signal produced by the modulation technique is represented by two solid dots on the I axis joined by two arrow-headed lines. The arrow-headed lines correspond to the possible values of the amplitude of the modulated signal during phase transitions. Due to the fact that the lines lie substantially on a circle around the origin of the Q and I axes, the modulated signal retains a substantially constant amplitude during phase transitions.

FIG. 3b illustrates a signal trajectory for a QPSK embodiment of the present invention. The complex analog signal produced by the modulation technique is represented by four solid dots joined by four arrow-headed lines. The arrow-headed lines correspond to the possible values of the amplitude of the modulated signal during phase transitions. As with the case of BPSK modulation illustrated in FIG. 3a, the lines lie substantially on a circle around the origin, and the modulated signal retains a substantially constant amplitude during phase transitions.

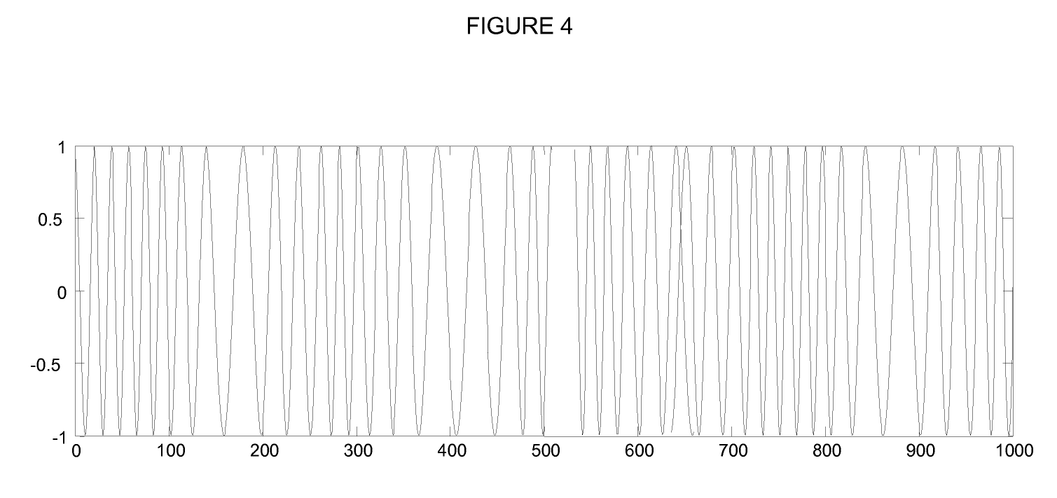

FIG. 4 illustrates a modulated signal that is consistent with the signal trajectories illustrated in FIGS. 3a and 3b. The modulated signal has a substantially constant envelope or amplitude. This constant-envelope modulation enables the use of a non-linear amplifier in the associated transmitter architecture. However, the constant-envelope modulation also tends to generate an output signal with a wider bandwidth than would be generated by the corresponding non-constant-envelope modulation. As is described in greater detail below, methods and apparatuses consistent with the present invention combine constant-envelope modulation with rotation-direction control to limit this widening of the output spectrum.

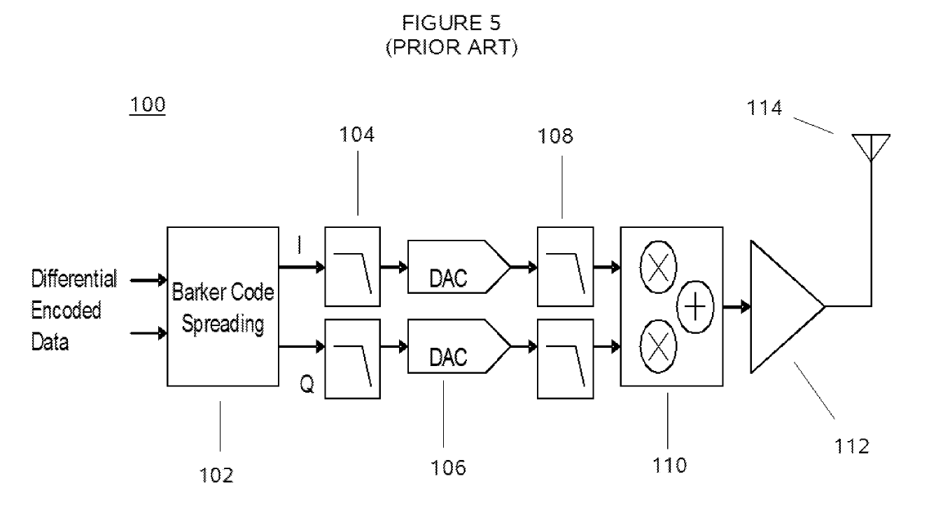

FIG. 5 illustrates a block diagram of a direct-conversion transmitter architecture 100 for a conventional IEEE 802.11 transmitter. The transmitter architecture 100 includes a Barker-code spreading circuit 102, a pair of filters 104, a pair of digital-to-analog converters 106, a second pair of filters 108, a mixer 110, a power amplifier 112 and an antenna 114. The Barker-code spreading circuit 102 generates a pseudorandom number (PN) code known as a Barker sequence. In IEEE 802.11, for example, the PN code is “10110111000”. Each bit of the incoming data is XOR'ed with the PN code. The bits resulting from this spreading operation are generally referred to as “chips” as opposed to “data”. Nevertheless, because methods and apparatuses consistent with the present invention are suitable for use in both spreading and non-spreading technologies, the use of the term “data” herein shall refer to either un-spread input data or chips.

Returning to FIG. 5, the separate I and Q signal paths from the Barker-code spreading circuit 102 are input into filters 104. The outputs of the filters 104 are input to digital-to-analog converters (DACs) 106, which convert the filtered data of the I and Q signal paths into corresponding analog signals. These analog signals are further filtered by additional filters 108 and then up-converted to radio frequency by the mixer 110. The up-converted signal is then provided to a power amplifier 112 for amplification before transmission by the antenna 114. Traditional implementations of the transmitter architecture 100 require a fully linear power amplifier 112, which adds significant complexity and cost to the transmitter architecture.

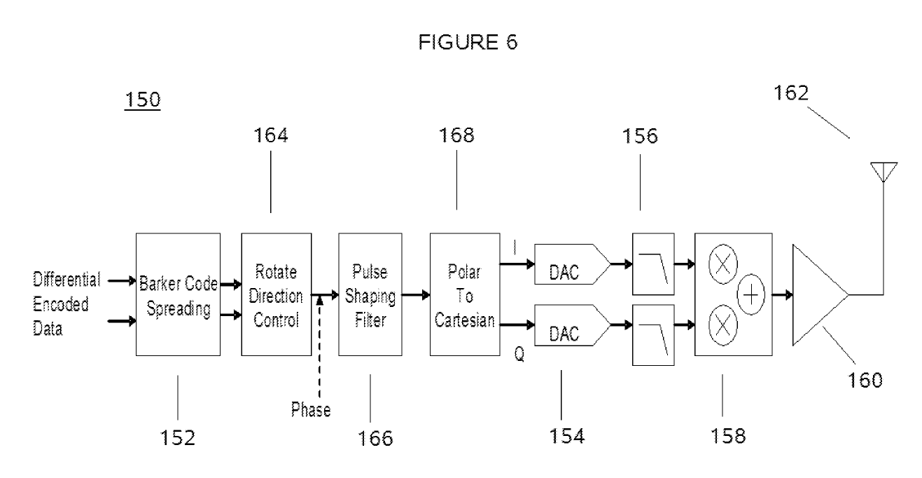

FIG. 6 illustrates a block diagram of a transmitter architecture 150 that is consistent with an exemplary embodiment of the present invention. Like the conventional IEEE 802.11 transmitter architecture discussed with reference to FIG. 5, this transmitter architecture may include a Barker-code spreading circuit 152, digital-to-analog converters 154, filters 156, a mixer 158, a power amplifier 160 and an antenna 162. In addition, according to one exemplary embodiment of the present invention, the transmitter architecture 150 may include a rotation-direction control circuit 164, a pulse-shaping filter 166 and a polar-to-Cartesian circuit 168. The rotation-direction control circuit 164 serves to limit the output spectrum of the modulated signal by altering the direction of phase rotations based on the occurrence of a predetermined pattern of data. The output of the rotation-direction control circuit 164, which is represented by phase variations, may then be input to a pulse-shaping filter 166 to further limit the output spectrum of the modulated signal by controlling the speed of phase rotations. In one exemplary embodiment of the present invention, the pulse-shaping filter 166 may be a Bartlett window with a pulse width equal to 2Tc. The variable Tc represents chip duration in spread-spectrum applications, such as IEEE 802.11 applications, and it represents symbol duration in non-spread-spectrum applications. The output of the pulse-shaping filter 166 may then be provided to a polar-to-Cartesian circuit 168 for separating the signal into I and Q components for further processing along I and Q signal paths.

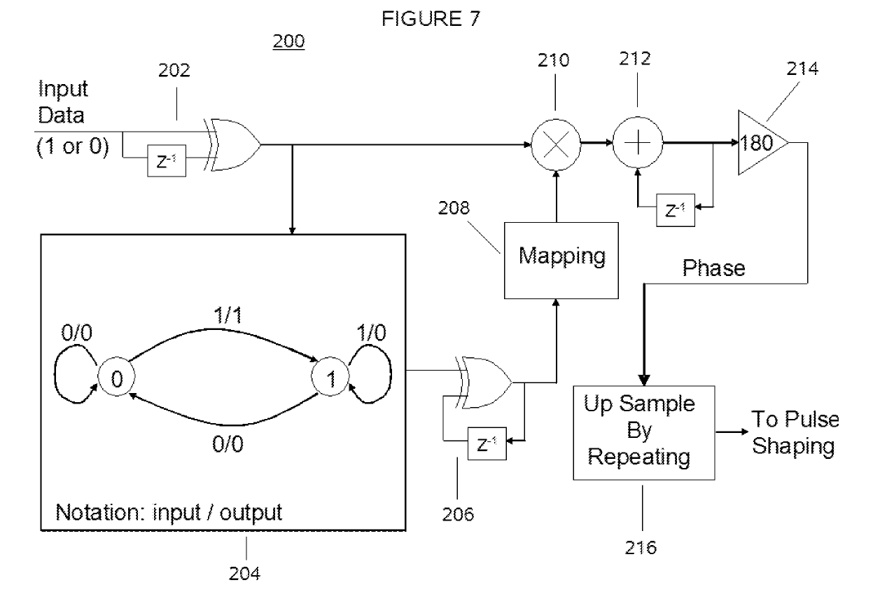

FIG. 7 illustrates a rotation-direction control circuit 200 for use with BPSK modulation that is consistent with an exemplary embodiment of the present invention. The rotation-direction control circuit 200 includes a phase-change detector 202 for detecting a change or transition in the input data. The output of the phase-change detector 202 is provided to a transition-analysis element 204. Examples of transition-analysis elements suitable for use with the present invention include, but are not limited to, state machines and counter circuits. The transition-analysis element 204 assists in the identification of the occurrence of predetermined patterns in the incoming data. Based on this identification, the transition-analysis element 204 varies the rotation direction of the phase modulation. The transition-analysis element 204 may, for example, generate an output of 0 to maintain the same rotation direction and an output of 1 to reverse the rotation direction. In the embodiment illustrated in FIG. 7, if the state machine 204 is in state 0 and receives an input of 0, it generates an output of 0 and remains in state 0. If the state machine 204 is in state 0 and receives an input of 1, it generates an output of 1 and transitions to state 1. If the state machine 204 is in state 1 and receives an input of 1, it generates an output of 0 and remains in state 1. If the state machine 204 is in state 1 and receives an input of 0, it generates an output of 0 and transitions to state 0. Those of skill in the relevant art will appreciate that the use of other various other state-machine algorithms are consistent with the present invention. It should also be noted that transition-analysis elements consistent with the present invention may be implemented in software, hardware or combination of both. Hardware implementations may include, but are not limited to, programmable logic devices, programmable logic controllers, logic gates and flip flops. Software implementations may include, but are not limited to, software programs intended to run on either general-purpose or special-purpose computers.

Returning to FIG. 7, the output of the state machine 204 may be provided to a direction-memory circuit 206. The direction-memory circuit 206 may store an indication of the status of the rotation direction and output an indication of the next desired rotation direction. The direction-memory circuit 206 may, for example, generate a 0 for a clockwise rotation and a 1 for a counter-clockwise rotation. The output of the direction-memory circuit 206 may be provided to a mapping circuit 208. The mapping circuit 208 maps the output of the direction-memory circuit 206 to a signal that is suitable for multiplication with the output of the phase-change detector 202. The mapping circuit 208 may, for example, map an input of 1 to an output of 1, while mapping an input of 0 to an output of −1. The output of the phase-change detector 202 and the mapping circuit 208 may be multiplied by multiplier 210 and the product of this multiplication may be provided to an accumulator circuit 212 and an amplifier 214. The accumulator circuit 212 essentially serves to reverse the phase-change detector 202, and the 180 degree amplifier 214 converts the signal into a phase representation. The phase representation of the data may then be provided to an up-sample-by-repeating circuit 216.

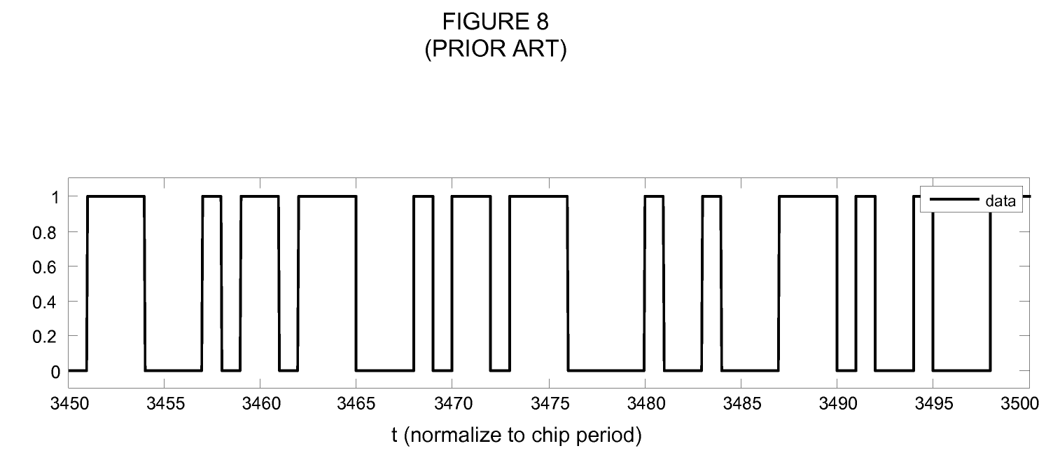

FIG. 8 illustrates an example of input data suitable for use with the exemplary embodiment illustrated by the combination of FIGS. 6 and 7. The vertical axis illustrates that the input data varies between a normalized value of 0 and 1. These normalized values may correspond to various actual voltage levels. The horizontal axis of FIG. 8 illustrates the sequence of input data over time, beginning with an input datum numbered 3450. For an input-data value of 1, the input-data signal remains at a level of 1 for a predetermined time corresponding to a single input datum. For an input-data value of 0, the input-data signal remains at a level of 0 for the predetermined time. If the input data changes from one value to the other, the input-data signal goes through a transition.

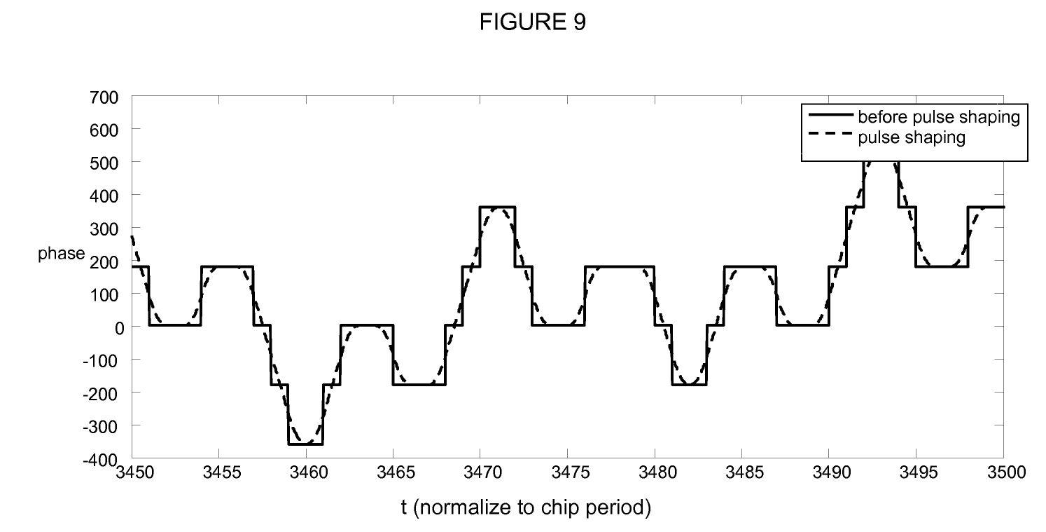

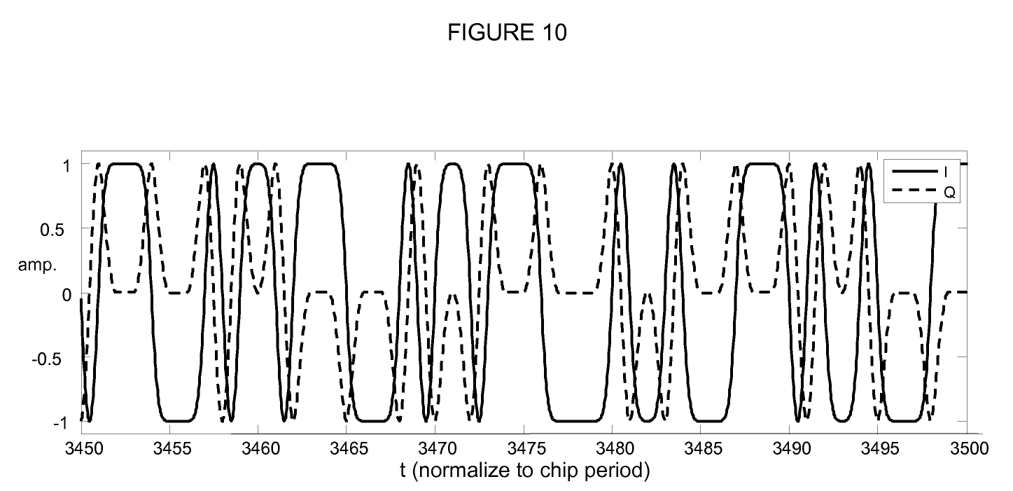

FIGS. 9 and 10 correspond to signals at various points in the transmitter architecture illustrated by the combination of FIGS. 6 and 7. FIG. 9 illustrates the input and output of the pulse-shaping filter. The input to the pulse-shaping filter, which corresponds to the output of the rotation-direction control circuit, is indicated by the solid line in FIG. 9. The output of the pulse-shaping filter, which corresponds to the input of the polar-to-Cartesian circuit, is indicated by the dashed line in FIG. 9. FIG. 10 illustrates the I and Q waveforms output by the polar-to-Cartesian circuit. The I waveform is indicated by the solid line, and the Q waveform is indicated by the dashed line.

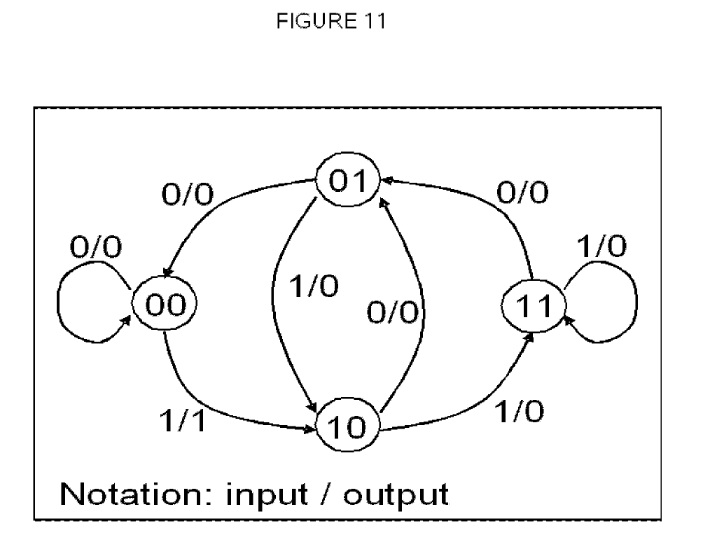

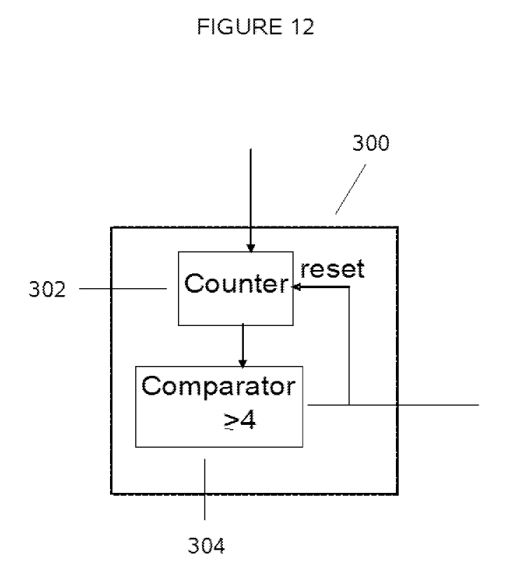

FIGS. 11 and 12 illustrate alternative embodiments of transition-analysis elements that are suitable for use with BPSK implementations of the present invention. FIG. 11 illustrates an alternative embodiment of a state machine that is suitable for use with the rotation-direction control circuit of FIG. 7. The conventions utilized in FIG. 11 for states and transitions are similar to those utilized in FIG. 7. FIG. 12 illustrates an exemplary embodiment of a counter circuit 300 that is suitable for use with the rotation-direction control circuit of FIG. 7. The counter circuit 300 may include a counter 302 and a comparator 304. The embodiment of the counter circuit 300 illustrated in FIG. 12 changes the direction of rotation after each sequence of four input data.

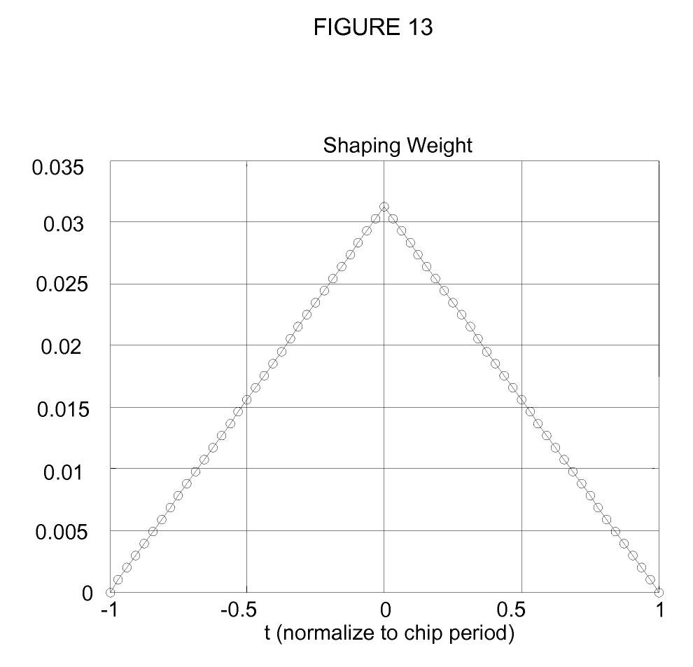

FIG. 13 illustrates the impulse response of a pulse-shaping filter that is consistent with an exemplary embodiment of the present invention. The impulse response that is illustrated corresponds to a pulse-shaping filter that is a Bartlett window with a pulse width equal to 2Tc. Although other pulse-shaping filter configurations are within scope of the invention, a Bartlett window has been determined to provide a good spectrum-to-EVM trade off.

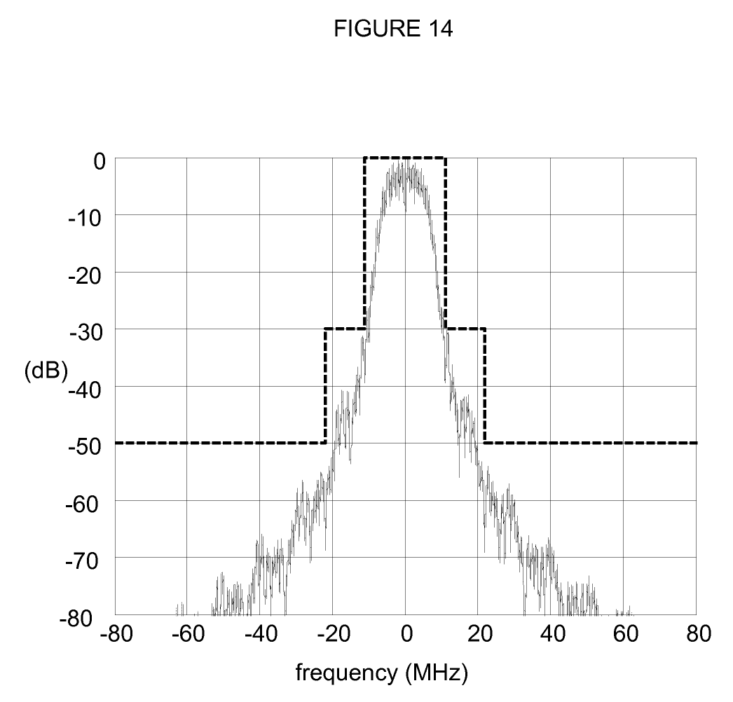

FIGS. 14 thru 17 illustrate the performance of the exemplary embodiment illustrated by the combination of FIGS. 6 and 7. FIG. 14 illustrates the output spectrum of the exemplary embodiment with a pulse-shaping filter configured as a Bartlett window having a pulse width of 2Tc. The dotted line represents the spectral mask of the IEEE 802.11 communications standard. As is illustrated by the containment of the output spectrum within the spectral mask, the frequency content of the output spectrum lies within the requirements of IEEE 802.11.

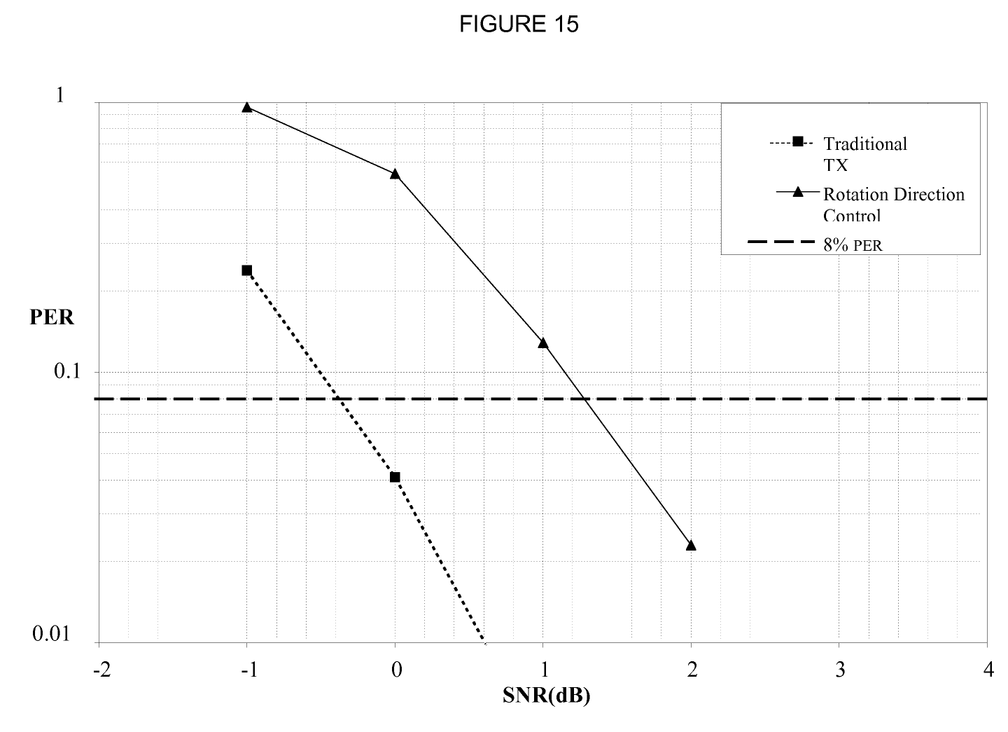

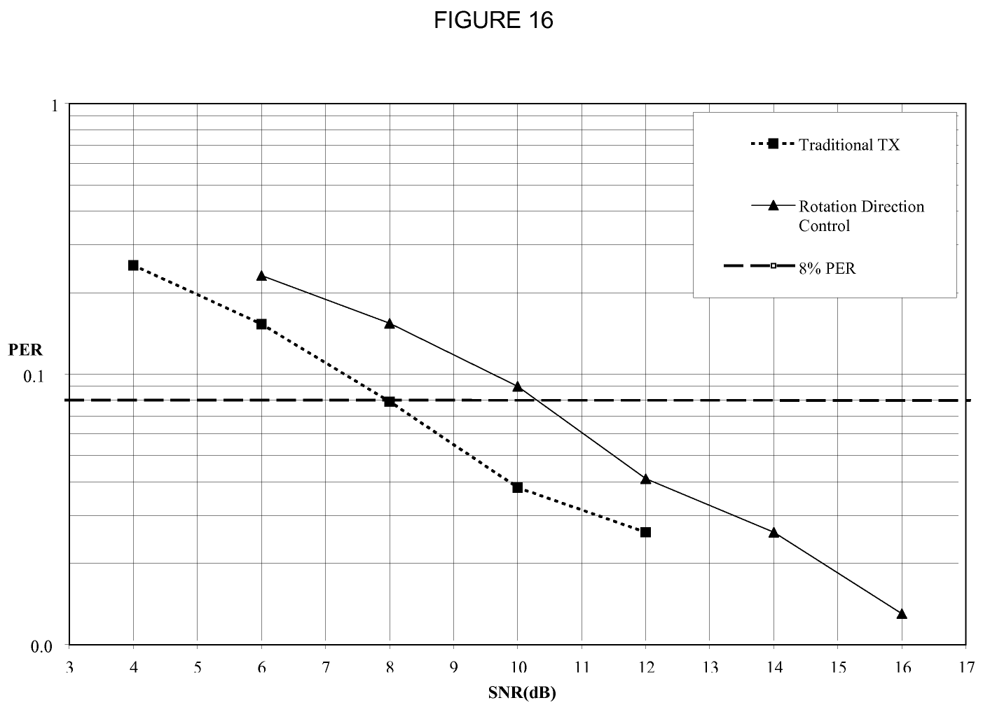

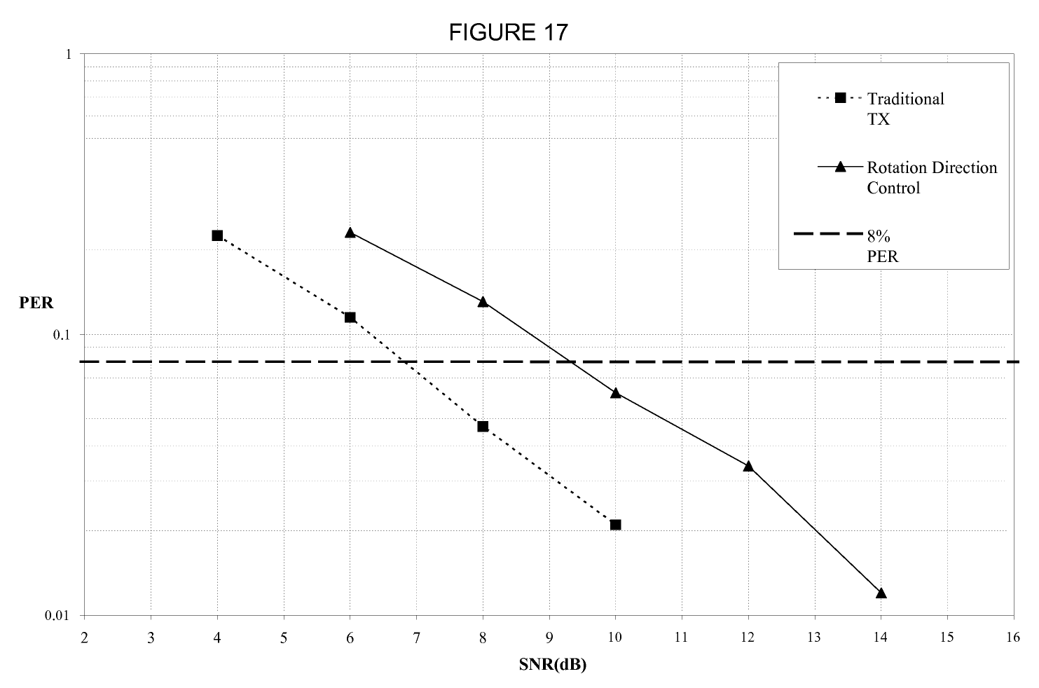

FIG. 15 illustrates performance degradation in an additive Gaussian white noise (AWGN) channel. FIG. 16 illustrates performance degradation in an exponential-decay Rayleigh fading multi-path channel with 25 ns delay spread. FIG. 17 illustrates performance degradation in an exponential-decay Rayleigh fading multi-path channel with 50 ns delay spread. In FIGS. 15 thru 17, the packet-error rate (PER) is shown on the vertical axis and the signal to noise ratio (SNR) in dB is shown on the horizontal axis. Each figure illustrates the performance of both a conventional IEEE 802.11 transmitter (labeled “Traditional TX”) and the transmitter embodiment formed by the combination of FIGS. 6 and 7 (labeled “Rotation Direction Control”). The baseline PER of 8% is also shown in each figure.

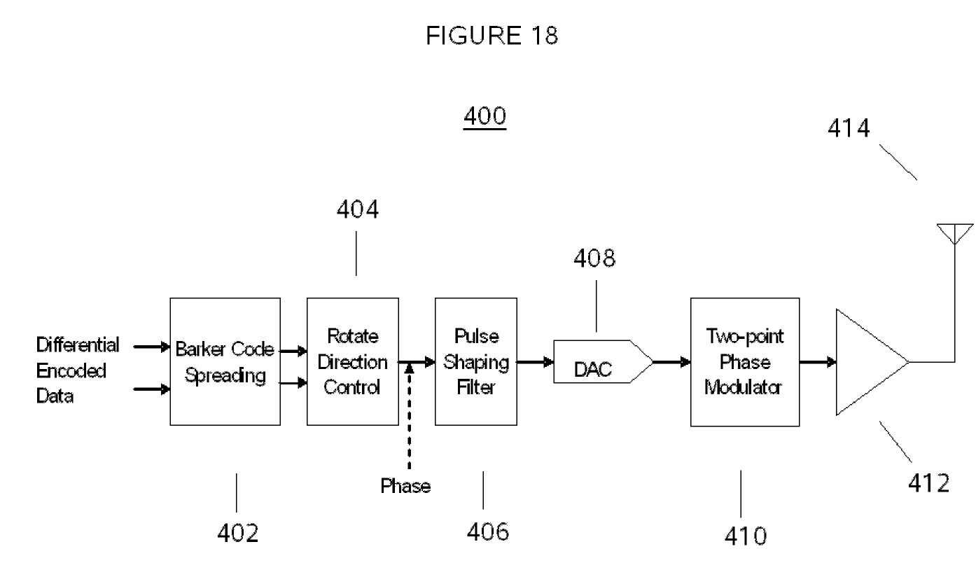

FIG. 18 illustrates an additional exemplary embodiment of a transmitter architecture 400 that is consistent with the present invention. The transmitter architecture 400 is similar to the transmitter architecture illustrated in FIG. 6 in that it may include a Barker-code spreading circuit 402, a rotation-direction control circuit 404 and a pulse-shaping filter 406. In this embodiment, however, the output of the pulse-shaping filter 406 may be fed to the antenna 414 via a single signal path rather than separate I and Q signal paths. The output of the pulse-shaping filter 406 may then be provided to a DAC 408, followed by a two-point phase modulator 410 and an amplifier 412.

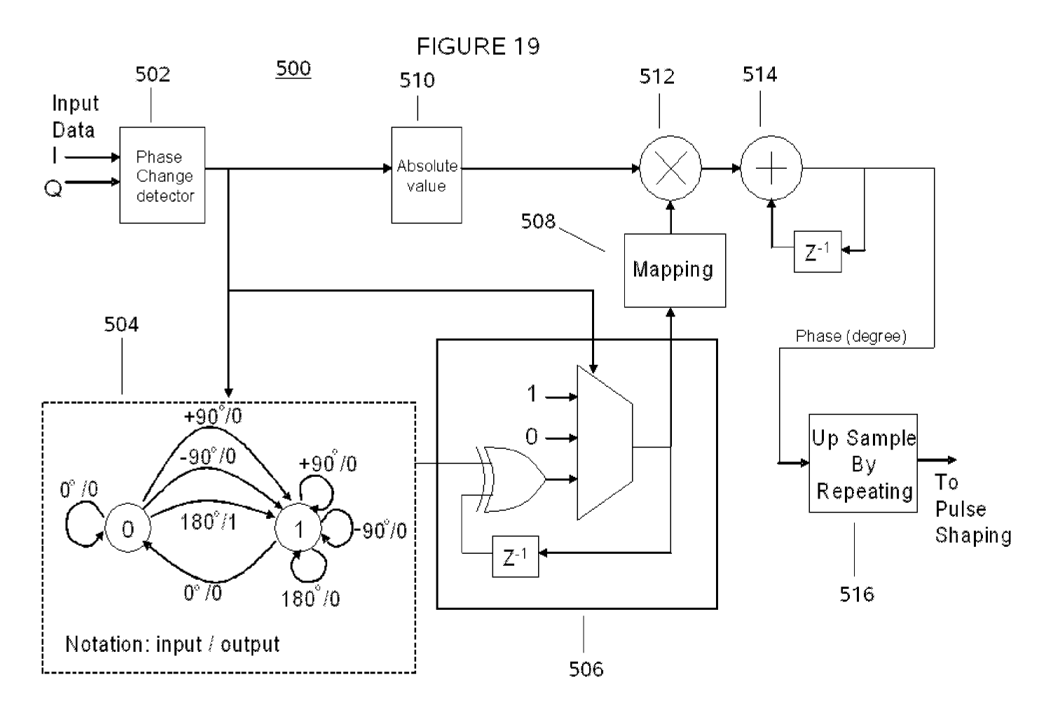

FIG. 19 illustrates an alternative embodiment of a rotation-direction control circuit 500 that is suitable for use with QPSK modulation. The rotation-direction control circuit 500 may include a phase-change detector 502 for detecting changes in the phase of the incoming data. The phase-change detector 502 may produce an output of, for example, −90, 0, +90 or 180 degrees. The output of the phase-change detector 502 may be fed to a state machine 504, an absolute-value circuit 510 and a direction-memory circuit 506. The absolute-value circuit 510 produces the absolute value of the output of the phase-change detector 502. For the phase values mentioned above, for example, this corresponds to 0, +90 or 180 degrees. The state machine 504 or other suitable transition-analysis element receives the output of the phase-change detector 502 and determines the desired rotation direction based on the occurrence of a predetermined pattern of incoming data. The state machine 504 may, for example, produce an output of 0 to maintain the same rotation direction and an output of 1 to reverse direction. The exemplary algorithm illustrated in FIG. 19 utilizes conventions for states and transitions similar to those illustrated in FIGS. 7 and 11. The direction-memory circuit 506 receives the output of the state machine 504 and may, for example, produce an output of 0 for a clockwise rotation and an output of 1 for a counterclockwise rotation. The direction-memory circuit 506 may include a mux that receives an input from the phase-change detector 502. In one embodiment, when the output of the phase-change detector 502 is +90 degrees, the output of the direction-memory circuit 506 is 1 (corresponding to counter clockwise rotation), regardless of the output from the state machine 504. Alternatively, when the output of the phase-change detector 502 is −90 degrees, the output of direction-memory circuit 506 is 0 (corresponding to clockwise rotation), regardless of the output from the state machine 504. Finally, when the output of the phase-change detector is 0 or 180 degrees, the state machine 504 determines the rotation direction. The mapping circuit 508, multiplier 512, accumulator 514 and up-sample-by-repeating circuit 516 may operate in a manner similar to the corresponding elements described with reference to FIG. 7.

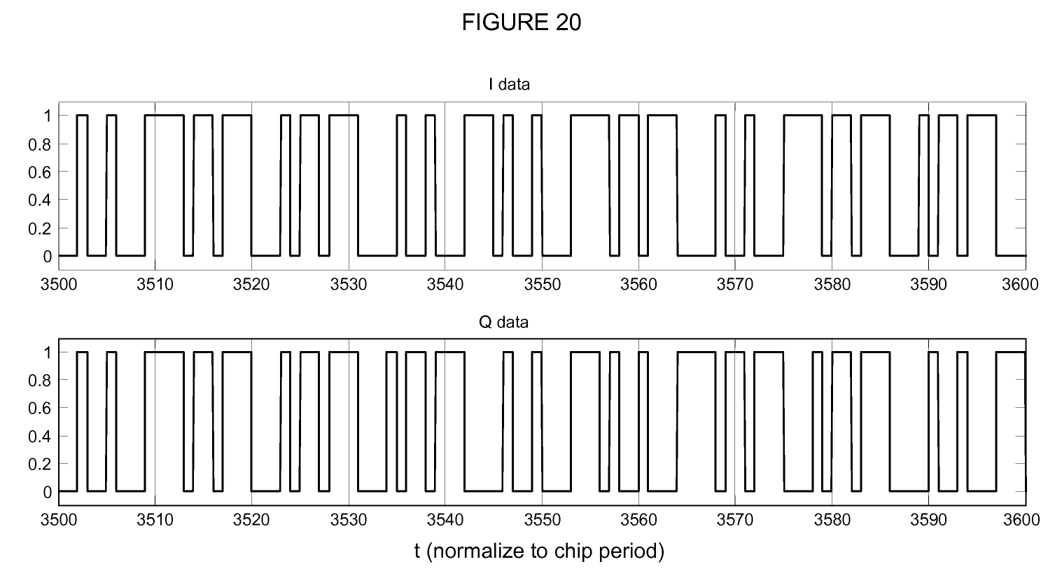

FIG. 20 illustrates input data for the exemplary embodiment illustrated by the combination of FIGS. 6 and 19. A separate graph is provided for the I data and Q data. The vertical axes illustrate the input data as varying between a normalized value of 0 and 1. The horizontal axes illustrate a sequence of input data, beginning with an input datum numbered 3500.

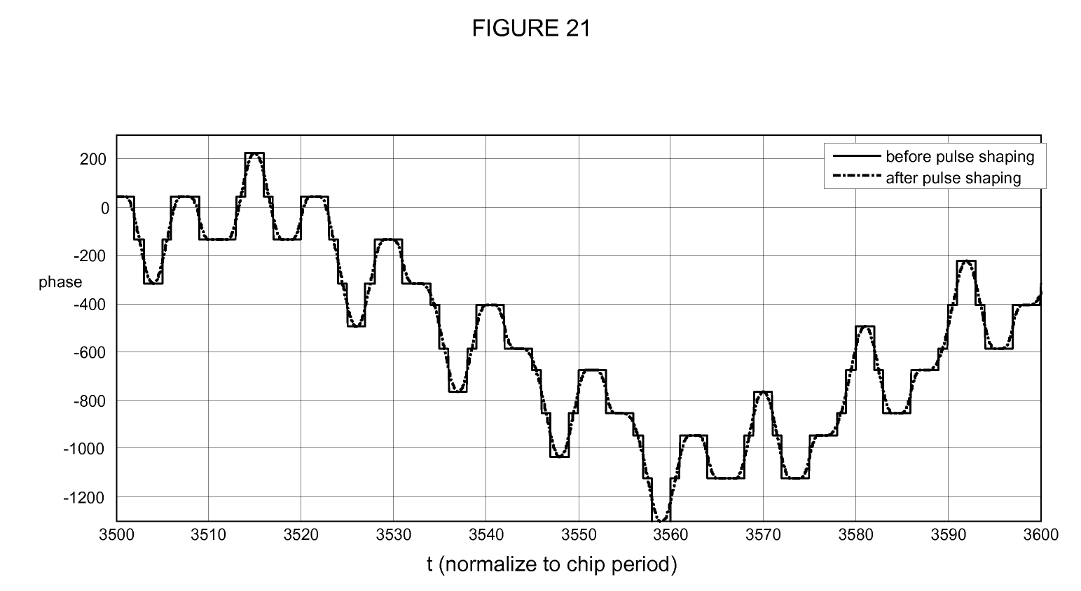

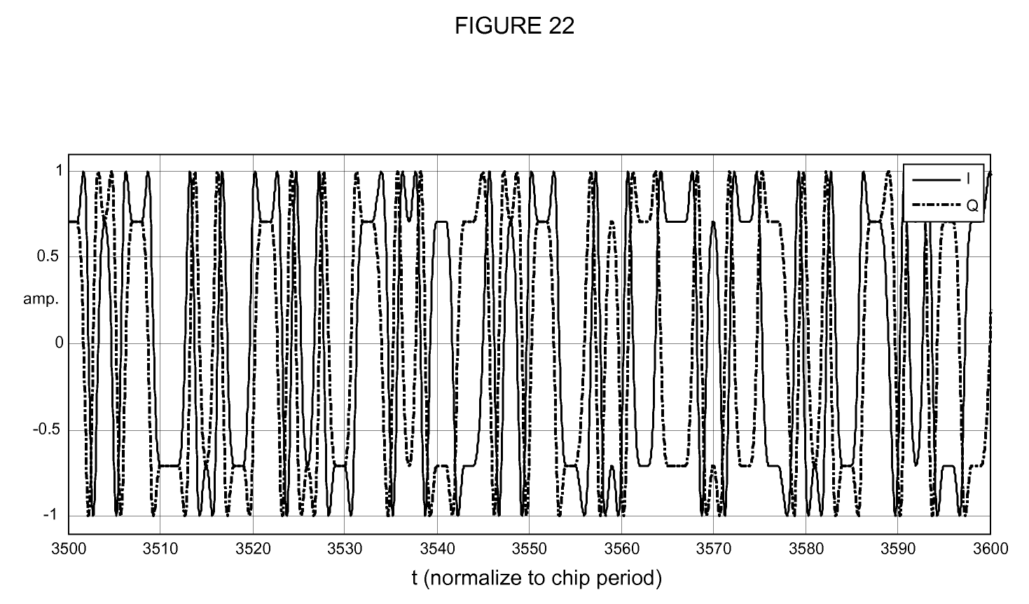

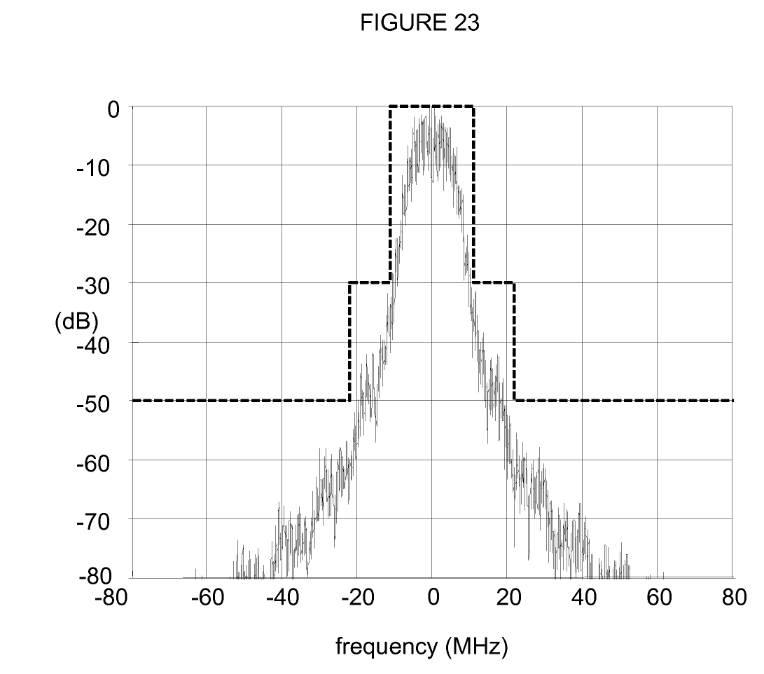

FIG. 21 illustrates the input and output of the pulse-shaping filter of the exemplary embodiment illustrated by the combination of FIGS. 6 and 19. The input to the pulse-shaping filter, which corresponds to the output of the rotation-direction control circuit, is indicated by a solid line. The output of the pulse-shaping filter, which corresponds to the input of the polar-to-Cartesian circuit, is indicated by a dashed line. FIG. 22 illustrates the I and Q waveforms output by the polar-to-Cartesian circuit. The I waveform is indicated by a solid line, and the Q waveform is indicated by a dashed line. FIG. 23 illustrates the output spectrum of this exemplary embodiment. The dotted line in the figure represents the spectral mask of the IEEE 802.11 communications standard. The frequency content of the output spectrum lies substantially within the spectral mask and therefore complies with the standard.

Although embodiments of the invention have been discussed primarily with respect to specific embodiments thereof, other variations are possible. For example, although references have been made to the IEEE 802.11 communications standard, one of skill in the relevant art will appreciate that methods and apparatuses consistent with the present invention are suitable for use with various other communications standards. In addition, although references have been made to BPSK and QPSK modulation, various other forms of M-ary modulation are suitable for use with the present invention. Moreover, steps associated with embodiments of the present invention may be performed by hardware or software, as desired. Steps can also be added to, taken from or modified from the steps in this specification without deviating from the scope of the invention. Those of skill in the relevant art will also appreciate that methods and systems consistent with the present invention are suitable for use in a wide range of communications applications, including but not limited to radio frequency identification (RFID) systems, cellular communication systems (including TDMA, CDMA, GSM, GPRS and WCDMA systems), as well as other wireless and fixed-line communications systems and information-processing systems.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention.

What is claimed is:

1. A method of controlling the output spectrum of a modulated signal generated by phase modulation, comprising:
varying a direction of rotation of a phase transition of said phase modulation based on the occurrence of a predetermined pattern of input data.

2. The method of claim 1 wherein said step of varying said direction of rotation comprises determining whether a phase change has occurred between two sequential data, and reversing said direction of rotation if no phase change has occurred between said two sequential data.

3. The method of claim 1 wherein said step of varying the direction of rotation comprises reversing said direction after the occurrence of each four sequential data.

4. The method of claim 1 wherein said predetermined pattern is selected to maintain said output spectrum of said modulated signal within a spectral mask dictated by a communications standard.

5. The method of claim 1 further comprising controlling said output spectrum by filtering said modulated signal with a pulse-shaping filter to control the speed of said phase change.

6. The method of claim 5 wherein said pulse-shaping filter comprises a Bartlett window with a pulse width of 2Tc.

7. The method of claim 5 wherein said phase modulation is selected from the group consisting of BPSK modulation and QPSK modulation.

8. The method of claim 5 further comprising the step of amplifying said modulated signal with a substantially linear power amplifier prior to transmission of said modulated signal.

9. A transceiver for generating a modulated signal by phase modulation, comprising:
a pulse-shaping filter for controlling the speed of phase changes of said phase modulation; and
a rotation-direction control circuit for varying the direction of rotation of said phase changes of said phase modulation based on the occurrence of a predetermined pattern of input data.

10. The transceiver of claim 9 wherein said pulse-shaping filter comprises a Bartlett window with a pulse width of 2Tc.

11. The transceiver of claim 9 wherein said rotation-direction control circuit determines whether a phase change has occurred between two sequential data, and reverses said direction of rotation if no phase change has occurred between said two sequential data.

12. The transceiver of claim 9 wherein said rotation-direction control circuit reverses said direction of rotation after each occurrence of four sequential data.

13. The transceiver of claim 10 further comprising a substantially linear power amplifier for amplifying said modulated signal prior to transmission.

14. The transceiver of claim 13 wherein said phase modulation is selected from the group consisting of BPSK modulation and QPSK modulation.

15. A communications terminal for generating a modulated signal by constant-envelope phase modulation, comprising:
a rotation-direction control circuit for varying the direction of rotation of phase transitions of said phase modulation based on the occurrence of a predetermined pattern of input data.

16. The communications terminal of claim 15 further comprising a pulse-shaping filter for filtering said modulated signal to control the speed of said phase transitions.

17. The communications terminal of claim 15 wherein said rotation-direction control circuit comprises a phase-change detector, a transition-analysis element, a direction-memory circuit, a mapping circuit, a multiplier, an accumulator; a phase amplifier, and an up-sample-by-repeating circuit.

18. The communications terminal of claim 15 wherein said transition-analysis element comprises a state machine for identifying the occurrence of said predetermined pattern of input data.

19. The communications terminal of claim 15 wherein said transition-analysis element comprises a counter circuit for identifying the occurrence of said predetermined pattern of input data.

20. The communications terminal of 17 wherein said phase modulation is selected from the group consisting of BPSK modulation and QPSK modulation.
